(19) United States
(12) Patent Application Publication
(10) Pub. No.: US 2008/0091358 A1
(43) Pub. Date: Apr. 17, 2008

(54) Method And System For Identifying Gene-Trait Linkages

(75) Inventor: Deanne Taylor, Rockland, MA (US)

Correspondence Address: HOWREY LLP, C/O IP DOCKETING DEPARTMENT, 2941 FAIRVIEW PARK DR, SUITE 200, FALLS CHURCH, VA, 22042-2924, US

(73) Assignee: Applied Research Systems ARS Holcing, N.V., Curacao (AN)

(21) Appl. No.: 11/722,315

(22) PCT Filed: Dec. 14, 2005
(86) PCT No.: PCT/US05/45286

§ 371 Date: Jun. 20, 2007

Related U.S. Application Data
(60) Provisional application No. 60/637,914, filed on Dec. 21, 2004.

(51) Int. Cl. G06F 19/00

(52) U.S. Cl. 702/19

(57) ABSTRACT

Utilization of genomic markers from whole-genome scans or gene association studies from one or more related disease/genetics publications to determinate possible single or average contribution of any gene to marker scores. The invention includes the ability to use multiple data sets from multiple publications to consider broader pools of genes as well as more accurately linking genes to a particular trait. The method includes algorithms to create scores to rank genes related to particular traits. The scores help a researcher determine genes that are the most promising to send through a more rigorous, time-consuming and expensive in vitro and/or in vivo trial program.

### BACKGROUND

Linkage analysis tests for co-segregation of a chromosomal region (or a marker) with a particular trait or phenotype. Such traits or phenotypes may include diseases caused by or associated with a particular genetic defect or defects or which create a predisposition or susceptibility to disease. Determining the association (e.g., cosegregation) of such markers and disease traits and characterization of those markers can ultimately result in the identification of therapeutic targets which through various interventions can result in a cure or the ameliorization of the disease trait.

The current state of the art includes mathematical tools for associating markers with genetic traits in single studies and does not include a method for mathematically associating markers to genetic traits with the use of gene scores from multiple studies and thus does not take advantage of abundance of data which may be brought to bear in attempting to identify and characterize specific genetic markers that play a role in disease or predisposition to disease. Thus, there remains a need for new methods which allow researchers to combine information from multiple studies to better determine which markers are most likely to be good targets for therapeutic intervention.

### SUMMARY

The present invention provides a method which utilizes genomic markers from whole-genome scans or gene association studies from one or more related disease/genetics publications, and a mathematical algorithm which allows the determination of the possible single or average contribution of any gene to the marker scores. The ability to use multiple data sets such as those found in more than one publication allows the method to both consider a broader pool of genes as well as more accurately determine which of the genes are linked to a particular trait. The method can be used for any genetic scan of any disease or trait and can be used to score any gene or genomic locus. Further the method can be implemented on multiple studies on multiple diseases with similar backgrounds.

The method produces several novel scores to rank the markers according to their linkage to a trait. Further, the method is able to use both a non-probabilistic and a probabilistic method to rank the markers. The method also combines non-probabilistic and probabilistic rankings. The scores the method provides are Average Contribution Scores for data in both a log-odds and an association p-value format. Further the method provides probability-weighted Average Contribution Score for data in both a log-odds and an association p-value format. Additionally, the method provides Evidentiary Scores that provide a researcher an indication of the validity of the contribution scores. The scores provide rankings that help a researcher determine those genes that are the most promising to send through a more rigorous, time-consuming and expensive in vitro and/or in vivo trial program.

The method is also directed to a computation system useful in the execution of the methods of the present invention. The computation system includes an input module to receive inputs of various genomic data and an output module to output the results of its calculations. A computation module performs the calculations. The results include scores for markers associated with genetic diseases or traits. A researcher also interactively uses the system in various manners including inputting data and changing parameters.

### FIGURES

FIG. 1 depicts a computation system that implements methods of the invention.

FIG. 2 is a flow chart of an algorithm for calculating average contribution scores for sequence features from genome-wide scans and the resulting LOD (log-odds) scores.

FIG. 3 is a pictorial representation of the calculation for Average Contribution Score.

FIG. 4 is a flow chart of an algorithm for calculating probability-weighted average contribution score (PACS).

FIG. 5 is a comparison of mouse joints in PAR-2−/− vs. +/+phenotypes, after induction of adjuvant arthritis.

FIG. 6 depicts the attenuation of Arthrogen-CIA induced arthritis in mice by p520.

FIG. 7 is an exemplary partial chart of original scoring for genomic markers.

FIGS. 8a and 8b are graphs of secreted proteins ACS scores for autoimmune diseases (RA, MS, PS, SLE).

### DETAILED DESCRIPTION

System

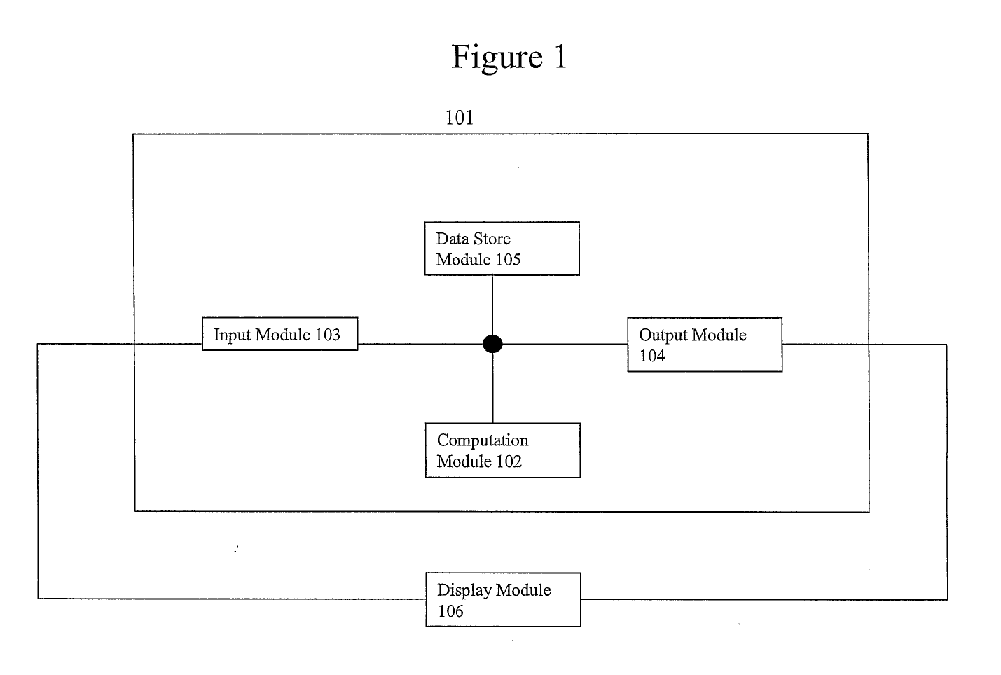

FIG. 1 depicts a computation system that implements methods of the invention. The system may be implemented with components or modules. The components and modules may include hardware (including electronic and/or computer circuitry), firmware and/or software (collectively referred to herein as “logic”). A component or module can be implemented to capture any of the logic described herein.

The system 101 includes the following interconnected modules: a computation module 102, an input module 103, output module 104, data store module 105, and a display module 106. The computation module receives data inputs from the input module 103. The computation module then obtains the method to execute from the data store module 105. Once the computation module 102 receives both the data inputs and method, it executes the method on the data inputs and outputs the results to the output module 104. The output module 104 then provides and reports the results to other modules such as keyboard/display module 106 so that the user of the system may review the results. The system also receives commands, such as algorithm initiation and parameter setting, from the user through keyboard/display module 106. The parameters affect the execution of the methods including files that store genomic mapping data.

The system also allows for correction, augmenting or enhancement of the methods performed. The user merely updates the methods stored in data store module 105 in order to change the method executed by the system 101. The update, for instance, includes the revising of software in data store module 105 to reflect the updated method.

Methods

There are three algorithms described below. The algorithms can be implemented with any genome version, public or private. These genomic data include the public genome versions available from public sources like the National Institute of Health or private genome versions provided by companies such as Celera. One algorithm is for calculating average contribution scores and another is for calculating probability weighted average contribution scores. The last algorithm combines the scores generated by the first two algorithms into a third score.

Algorithm for Calculating Average Contribution Score for Sequence Features from Genome-Wide Scans and the Resulting-LOD (Log-Odds) Scores

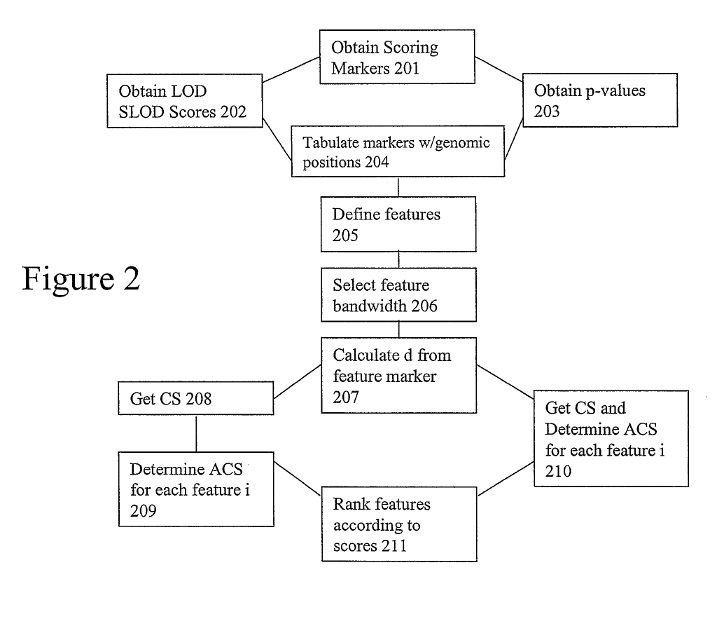

FIG. 2 is a flow chart of an algorithm for calculating average contribution score for sequence features from genome-wide scans and the resulting LOD (log-odds) scores. A sequence feature is a feature, a genomic feature or a feature with a physical location on a chromosome. The algorithm uses study data and a genomic map as inputs and then outputs Average Contribution Scores. The algorithm is implemented as part of the logic of the system.

The algorithm begins with genomic association data obtained from a study or studies of genome-wide scans that score markers according to probabilistic studies of genomic linkage to traits, such as a disease 201. The algorithm utilizes a collection of studies on a single disease, or a collection of studies on multiple different but related diseases, such as a set of autoimmune diseases. The data from the studies represent markers of genomic locations (markers) and a probability score attached to each marker. The type of score depends on the type of study done. However, these probability-based scores all represent, directly or indirectly, the probability of any marker (genomic locus) being associated with the manifestation of a disease within a studied population. Generally, the scores will be included in the studies themselves. However, a researcher using the system and method may also calculate the scores from information in a published study, from other laboratory generated data, from other sources of genomic data, or any combination thereof.

For instance, the probability scores include: (1) the log-odds (LOD) likelihood of a genomic region associated with a disease, and (2) the association p-value (ASN) from regional scans. These scores result from calculations of genome-wide scan data in the case of LOD scores, or association scans in the case of association scores. An example of a genome-wide scan is given in Kong A, Cox N J (1997) Allele-sharing models: LOD scores and accurate linkage tests. Am J Hum Genet 61:1179-88. Other methods that express the probability of a genomic location being associated with a disease also can be used with the algorithm by replacing the LOD or ASN scores with the other method's corresponding score. The rest of the steps of the algorithm would remain relatively unchanged.

The LOD scores determined from the studies are represented as S_{LOD} 202. The ASN scores determined from the studies are represented as S_{ASN}. The S_{ASN} are derived from associated p-values p_{ASN} with the equation S_{ASN}=(1−p_{ASN}) 203. The p_{ASN} is determined by reviewing the studies. The p-value of association as reported in the literature from association studies can also be converted into a probability score S when normalized to one. In the cases where association scores are not presented as p-values, the association scores are converted into p-values and then calculate for S. The probability scores S_{LOD} and S_{ASN}, as they are associated with specific genetic/genome location markers, are then tabulated with the associated marker and its genomic position and recorded 204.

Features are then selected 205. The features include any sequence element of interest, including genes, transcriptional regulatory regions, untranslated regions and intergenic regions. A feature locus is the genomic location that corresponds to a feature.

The features are located on the same chromosome as the markers that are selected 206. Further refinement on selecting features includes selection of features in the vicinity of each marker or markers, or the selection of a certain class of feature in the vicinity of the marker or markers. If selection is based on vicinity to a marker(s), the selected vicinity may be within 10 Mb\10 cM of a marker, or broadly based on a feature locus sharing the same chromosome as a marker. As the range of the selection is enlarged, asymptotic effects of the algorithms cause the features far from the markers to have a limited effect.

The distance between the feature loci and the scored marker is calculated 207. The distance calculation may be performed using any relevant metric to calculate distance between genetic loci including: radiation hybrid, genetic and physical distances.

As a first example, when using physical (nucleotide) distance, the method divides the marker's score S by the selected distance of the feature locus to that of the marker locus 208. The result is the contribution score (CS) of that feature's position versus one particular marker position. The algorithm then samples from all markers in the feature's vicinity or chromosome. The average score for that feature against all markers is the ACS, average contribution score for nucleotide distance.

$$A C S = {\sum }_{i} \frac{{S}_{i}}{{d}_{i}} \qquad ( 1 )$$

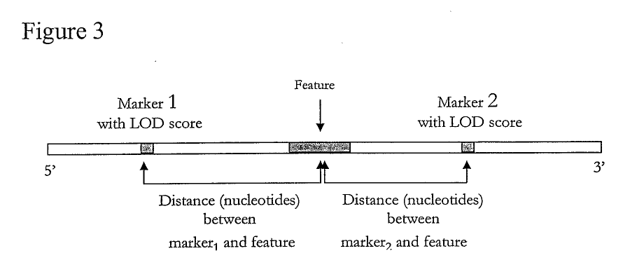

In equation (1), d₁ is the feature distance to the scored markerᵢ in nucleotides and Sᵢ is the probability score. FIG. 3 is a pictorial representation of the calculation for the ACS. The ACS score is used to generate rankings according to the ACS to elucidate features associated with markers in the vicinity of the feature locus 211. The higher the score, the more likely the features are associated with the marker.

As a second example, the algorithm can use the average reported recombination rates between the marker and the feature from public-domain sources to transform the nucleotide distance into genetic distance in centiMorgans (cM). This allows for normalization of marker-feature recombination rates and provides a genetic distance between the two 210. This ACS represents the average genetic distance in cM and is described in equation (2).

$$A C S = {\sum }_{i} \frac{{S}_{i}}{{d}_{i} \cdot {R}_{i}} \qquad ( 2 )$$

In equation (2) the average recombination rate (Rᵢ) is calculated between a feature and LOD marker i. Further, the average recombination rate in cM/Mb and dᵢ is the feature distance to markerᵢ as reported in Mb. The ACS score can be used like the nucleotide ACS score to determine the relative rankings for possible contribution of sequence feature elements and markers 211.

The relative ACS_{LOD} and ACS_{ASN} can differ for the same genes, as both scores reflect different approaches to studying populations and probability-scoring mechanisms, and as such may not be directly comparable. Therefore, both scores should be calculated separately from the different data sources.

The above algorithm can be used stand-alone, or as part of a pipeline or other process to score genes according to additional criteria such as literature or expression data.

Algorithm for Calculating Probability-Weighted Average Contribution Score (PACS) for Sequence Features from Genome-Wide Scans and the Resulting Scores

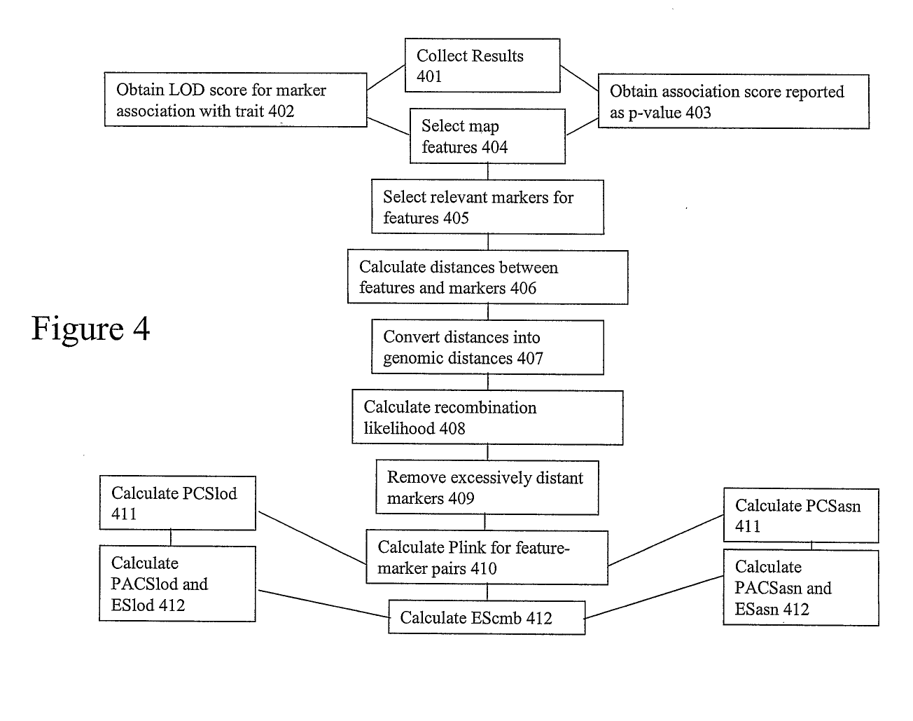

FIG. 4 is a flow chart for an algorithm for calculating probability-weighted average contribution scores (PACS). The algorithm uses study data and genomic maps as inputs and outputs Average Contribution Scores and Evidentiary Scores. The algorithm is implemented as part of the logic of the system.

The algorithm begins with the collection of a series of results on genetic studies of disease where the results relate genomic locations to genetic scores associated with a trait (i.e. genomic association data), such as a disease, within a population 401. There are two main types of scores for genetic markers, log-odds likelihood and association scores.

A log-odds (LOD) score is the likelihood of a marker being associated with selected physiological manifestations such as traits, diseases or other biological condition. These data represent LOD scores per genomic sequence markers used in the study or studies. These scores result from genome-wide scans (yielding linkage, LOD (log-odds) scores) as given for instance in the Kong et al. paper referenced below. The LOD scores are reported as numerical values.

Association scores result from genetic association studies such as those obtained from high-resolution scans of genomic regions. The association scores are reported as p-values with decreasing numbers indicating increasing probability.

Numerical LOD 402 or association 403 scores for these markers are obtained from the study or studies. The studies can be focused on one disease type, or several disease types that are believed to be associated in some way, such as a collection of results on different autoimmunity diseases, or several studies on metabolic diseases. LOD and association scores are separate types of scores and processed separately by the algorithm. The algorithm tabulates these marker scores along with the marker name, the score type (LOD or association), and the marker's obtained genomic position, using a mapping program such as BLAT or BLAST. These steps 402, 403 yield j LOD scores and k association scores.

As described above, genomic features include any sequence element of interest, including genes, transcriptional regulatory regions, untranslated regions and intergenic regions. The algorithm scores those features to determine the likelihood that they contribute to the LOD or association scores as determined from the genetic studies. The algorithm also maps all features to the genome using a mapping program such as BLAT or BLAST 404.

The algorithm then iterates over the mapped features the following calculations:
The algorithm selects disease markers on the same chromosome or those markers regional to the feature (such as markers within 10 Mb/10 cM of the feature) 405. The algorithm then calculates the distance between the feature locus and a scored disease marker 406. The distance measure can be of any of several measures of distance between two genomic loci including radiation hybrid distance, genetic distance (centiMorgans) and nucleotide distance (basepairs). One method of calculating the genetic distance between a scored disease marker and the associated feature is with the use of a metric, such as the Decode high-resolution genetic map of the human genome as described in Kong A, et al., A high-resolution recombination map of the human genome Nature Genetics (Vol. 33 No. 3).
The algorithm then performs a conversion to genetic distance, so that the final distance measure between the feature and the disease marker is reported in centiMorgans (cM) 407. The algorithm, in one embodiment, converts centiMorgans into an observed recombination through equations like the Kosambi function (described in Kosambi, D. D., 1943 “The estimation of map distances from recombination values.” Ann. Eugen. 12:172-175) if one is using the Decode genetic distances as a metric described in the Kong reference. However, when using the Kosambi function, centiMorgans are roughly equal to percentage recombinations in a linear fashion, up to about 10 centiMorgans. Any feature-disease marker distance beyond 10 centiMorgans with the Kosambi map distance are converted into the likelihood of recombination using a method of the genetic metric map used for accuracy.
The percentage of observed recombinations between two loci is the probability that any two loci will recombine. The algorithm determines the “recombination likelihood”, rl 408. The rl is the genetic distance d_{g} between a feature and the disease marker, in centiMorgans, divided by 100 as described in equation (3). This equation holds for all marker-feature distances less than 10 cM. If the distance is greater than 10 cM, the rl is calculated with the method of the map used.

$$r l = \frac{{d}_{g}}{100} \qquad ( 3 )$$

For instance, if a genetic distance between a feature and a disease marker is calculated as 2.7 centiMorgans using the Decode map of the Kang reference as a metric, the recombination likelihood value used in the calculation is: 2.7/100=0.027. The conversion to recombination likelihood is performed in a single or multiple steps. For example recombination rates can be utilized to convert between nucleotide distance and genetic distance. The genetic distance can then be converted to the recombination likelihood or other metric.

Genetic distances between the feature and the marker that are greater than 100 centiMorgans may be omitted due to asymptotic effects and in one embodiment are left from the calculation 409. The LOD score, as a log-odds score, is left intact for the calculation so that S_{LOD}=LOD score, as determined from the studies. On the other hand, the association score, as a p-value (pₐₛₙ), is defined as Sₐₛₙ=(1−pₐₛₙ).

For the feature-marker pair, the algorithm calculates the probability that this feature locus and the marker will NOT recombine relative to one another 410. This probability, the Plink, is given by equation (4).
Pₗᵢₙₖ=(1−rl) (4)
In equation (4), rl is the recombination likelihood (rl) between the disease marker and the feature locus. In the case where rl is very small, Pₗᵢₙₖ will be close to one, and when rl is large, Pₗᵢₙₖ will decrease towards zero. Therefore, Pₗᵢₙₖ represents a probabilistic adjustment to the LOD score based on genetic distance.

The algorithm in turn now multiplies Pₗᵢₙₖ with that marker's LOD or association score (S) as described in equation (5). This value is defined as the probability-weighted contribution score (PCS), which represents a probability-adjusted score (LOD or association score) for the feature versus disease marker i of j total markers.
PCS=PₗᵢₙₖSᵢ (5)

The algorithm further identifies PCS_{LOD} for the probability-weighted contribution LOD score, and PCS_{ASN} for the probability-weighted contribution association score 311. The CS_{LOD} and CS_{ASN} are considered separate types of scores and are kept independent of one another during the derivation.

The algorithm continues to sample from the N LOD-scored disease markers, and the M association-scored disease markers in the feature's selected vicinity. The algorithm keeps the LOD and association score calculations distinct and separate. At the end of the calculation, the algorithm provides two independent groups of data for each feature. It creates N probability-weighted LOD contribution scores (PCS_{LOD}) for this single feature. It also creates M probability-weighted association contribution scores (PCS_{ASN}) for this single feature.

From the LOD and association scores, the algorithm produces five score values, the probability-weighted average contribution score (PACS) and the evidentiary score (ES) which is the non-normalized PACS score 412:
a. PACS_{LOD}: A sum over the PCS_{LOD} scores for that feature, normalized by the number of LOD-scored markers N (Eqn 6)
b. ES_{LOD}: A sum over the PCS_{LOD} scores for that feature (Eqn 7)
c. PACS_{ASN}: A sum over the PCS_{ASN} scores for that feature, normalized by the number of association-scored markers M (Eqn 6)
d. ES_{ASN}: A sum over all PCS_{ASN} scores for that feature (Eqn 7)
e. ES_{CMB}: a combined sum over all PCS_{LOD} and PCS_{ASN} for that feature (Eqn 6)

$$\begin{matrix}P A C S = \frac{1}{n} {\sum }_{i} ( 1 - r {l}_{i} ) {S}_{i} & ( 6 ) \\ E S = {\sum }_{i} ( 1 - r {l}_{i} ) {S}_{i} & ( 7 )\end{matrix}$$

The PACS (probability-weighted average contribution score) is an averaged PCS score, and represents the feature's score in terms of LOD or association, as a contribution from each disease marker. The PACS score represents the average adjusted LOD or association score. The algorithm provides the relative rankings of PACS scores. The relative ranking of the PACS scores allows a user to determine those features that may best contribute to the LOD or association scores in the arrangement of markers from the genetic studies. Specifically, the algorithm reports the PACS_{LOD} and PACS_{ASN} scores. The PACS_{LOD} and PACS_{ASN} scores represent different types of data that can be difficult to combine. However, both can simultaneously be used in a selection process to score or rank features of interest as both provide information on the likelihood a given gene will be a good candidate for further study.

While calculating “probability-weighted average contribution score” (PACS) for a single feature of equation (6) Sᵢ is the marker i's LOD or association score, rlᵢ is the recombination likelihood between the feature and the marker i in Morgans, and n is the number of markers used to calculate the PACS.

The ES is the evidentiary score. It is used as a relative score, to rank those features that show the “best evidence” for association with disease(s). Also one can combine ES_{LOD} and ES_{ASN} into ES_{CMB} as combined evidentiary scores, which represent the sum total of evidence that a feature may contribute to the genetic scores of disease markers. The ES score provides the researcher with an indication as to the reliability of the associated ACS and PACS scores.

While calculating the “evidentiary score (ES)” for a single feature, the Sᵢ is the marker i's LOD or association score, and rlᵢ is the recombination likelihood between the feature and the marker i in Morgans.

The PACS or ES can be used alone or together to calculate the relative ranking of features to select them for further study, exploration, and discovery. The above algorithm can be used stand-alone, or as part of a pipeline or other process to score genes with additional criteria such as literature or expression data.

Algorithm for Calculating a Combined Contribution Score

After calculating the ACS and PACS scores for association scores and p-values, the method allows for these scores to be combined in a number of different methods. One method to combine the scores is to first determine the rankings generated for the markers by the ACS_{LOD}, ACS_{ASN}, PACS_{LOD} and PACS_{ASN} scores. Then, ACS_{CMB} (ACS Combined) and PACS_{CMB} (PACS Combined) scores are generated by re-ranking the markers based on the average ranking of the two ACS and two PACS scores, respectively. Another method of combining the scores would be to generate new ranking based on weighted ranking of the two ACS and two PACS scores. The weighting could be based on the generated ES scores.

### EXAMPLES

### G-Protein Coupled Receptors

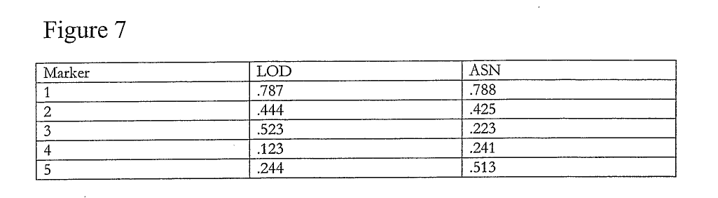

As an example, a subset of the genomic compliment called the GPCRs, the G-Protein Coupled Receptors, were examined using the algorithm describe above. The scores used by the algorithm were generated from the literature. An example of a portion of the scores used by the algorithm is shown in FIG. 7. These types of scores may be derived from the papers, such as those in Appendix A. The papers listed in Appendix A are incorporated by reference.

After ranking the ACS_{LOD} scores of the GPCRs, the top five non-olfactory receptor hits found in order of relative score were:

1. Proteinase activated receptor 2 precursor (PAR-2)

2. Human seven transmembrane signal transducer PGR1

3. Probable G protein-coupled receptor GPR35

4. Proteinase activated receptor 1 precursor (PAR-1) (Thrombin receptor)

5. Putative G-protein coupled receptor, EDG6 precursor

In the example, the literature was mined for studies related to autoimmune diseases (with both LOD and p-values). Then a list of genomic regions on Celera R27 associated with four autoimmune diseases (MS, PS, SLE and RA) was assembled.

Further, only markers were selected that possessed a whole-genome scan LOD score of greater than 1.0 (with some exceptions made for values below but very close to 1.0), or actual genetic association P-values less than 0.005. However, all regions even with sub-optimal scores were retained, and all LOD or association scores are paired with the marker information to allow for scoring choices and future meta-analyses.

The example used the following papers to determine the original scores.
Multiple Sclerosis: Ban (2002), Coraddu (2001), Dyment (2001), Ebers (1996), Haines (1996), Haines (2002), Kuokkanen (1997), Saarela (2002), Sawcer (1996), the Transatlantic Multiple Sclerosis Genetics Cooperative (2001), Xu (1999).
Psoriasis: Enlund (1999), Lee (2000), Matthews (1996), Nair (1997), Samuelsson (1999), Speckman (2003), Tomfohrde (1994), Trembath (1997), Veal (2001).
Rheumatoid Arthritis: Cornelis (1998), Jawaheer (2001), Jawaheer (2003), MacKay (2002), Shiozawa (1998).
SLE: Gaffney (1998), Gaffney (2000), Grey-McGuire (2000), Johanneson (2002), Lindqvist (2000), Moser (1998), Namjou (2002), Nath (2001), Scofield (2003), Shai (1999), Tsao (2002).

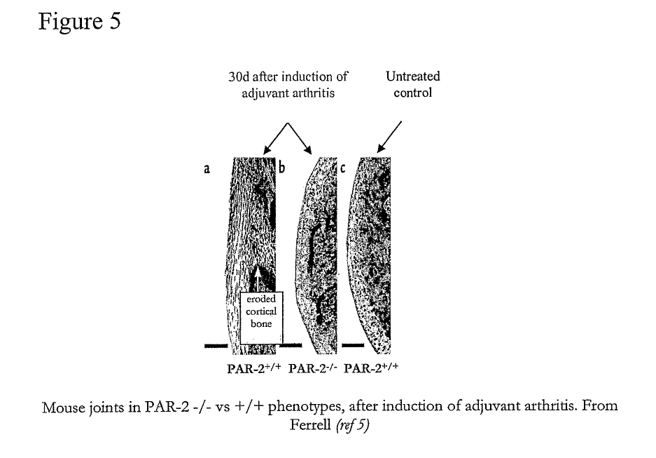

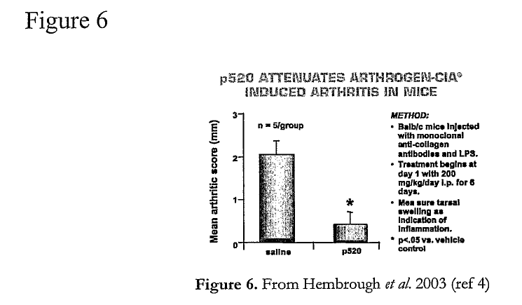

As mentioned above, Par-2 was found to have the highest ACS_{LOD} scoring receptor. PAR-2, is a receptor implicated in nociception and inflammatory processes. This receptor has recently (Ferrell, infra., January 2003) been validated in the literature as a key inflammation target. The algorithm scored PAR-2 as possibly contributing to MS and RA genetic marker LOD scores. Thus, our algorithm appropriately scored this receptor as being linked to RA. FIG. 5 shows a figure from a publication on PAR-2 (Ferrell W R, Lockhart J C, Kelso E B, Dunning L, Plevin R, Meek S E, Smith A J, Hunter G D, McLean J S, McGarry F, Ramage R, Jiang L, Kanke T, Kawagoe J. (2003) “Essential role for proteinase-activated receptor-2 in arthritis.” J. Clin. Invest. 11: 35-41). The figure demonstrates that this receptor is important to destruction of bone and joint tissue in induced adjuvant arthritis. Additionally, a company called Entremed currently has antagonists for this receptor. These antagonists are able to decrease the mean arthritic score as shown in another paper incorporated as FIG. 6 (Hembrough T. A., Swerdlow B., Swartz G. M., Plum S, Smith W., Fogler W. and Pribluda V. S. (2003) “Novel antagonists of Par-2: inhibition of tumor growth, angiogenesis, and inflammation.” Blood 2003,102:11 (poster abstract)). As PAR-2 is also implicated in our method with MS, it may be interesting to study MS models with this receptor or its antagonists.

G-Protein Coupled Receptors Data Output

The data from the G-Protein Coupled Receptor study are provided and reported to a researcher in several useful formats. The first type of statistical data output is a table such as Table 1.

TABLE 1

| | | Autoimmune | | | | Number of | | |
|---|---|---|---|---|---|---|---|---|
| | Gene | diseases with | Markers found | | | distinct LOD | | Number of distinct |
| mRNA | location | markers cited | cited in | | | scores for | ACS(assn) | association scores |
| ID | (Mb) | for this location | literature | Chromosome | ACS(LOD) | these markers | likelihood | for these markers |
| NM_0001 | 24212312 | PS | D3S121 | 8 | 211.75297 | 2 | 0 | 0 |
| NM_0002 | 124124123 | RA, PS, SLE, MS | D3S121 | 3 | 155.023788 | 27 | 106.8355759 | 20 |
| NM_2010 | 3432423 | RA, PS, SLE, MS | D9S821, D1S999 | 3 | 130.460561 | 27 | 89.90379706 | 20 |
| NM_9811 | 2343243 | PS, RA, SLE | D7S891 | 8 | 104.259825 | 9 | 0.708392182 | 2 |
| NM_7871 | 5621634 | SLE, MS | D2S423 | 5 | 76.5186646 | 4 | 0 | 0 |
| NM_1311 | 23423423 | SLE, PS | D8S9812 | 12 | 69.427699 | 15 | 0.165091906 | 2 |
| NM_4441 | 23525111 | MS, SLE | D12S231 | 1 | 65.1666746 | 6 | 0.271976917 | 2 |
| NM_1242 | 12312898 | MS, SLE | D5S999 | 3 | 61.0424312 | 6 | 0.271921687 | 2 |
| NM_2142 | 32141223 | SLE | D3S122 | 5 | 54.9621027 | 1 | 0 | 0 |
| NM_3214 | 33241444 | RA, PS, SLE, MS | D8S4444 | 4 | 51.3234934 | 27 | 35.3540505 | 20 |
| NM_12421 | 151242112 | SLE | D15S999 | 3 | 38.8487553 | 5 | 0 | 0 |
| NM_2342 | 4213213 | SLE, MS | D98S712 | 1 | 38.5173789 | 4 | 0 | 0 |

Table 1 is a partial exemplary chart of scores calculated and reported by the system and method of the invention for G-Protein Coupled Receptor ACS scores for autoimmune diseases (RA, MS, PS, SLE). This exemplary chart provides the information for the proteins (features) in the study with the twelve highest ACS_{LOD} scores. The chart includes for each protein: mRNA_ID, gene location, associated diseases with markers cited for the gene location, the name of the markers in the literature, chromosome, ACS_{LOD} score, the number of LOD-scores used in the method's calculations, ACS_{ASN} score, and the number of association scores used in the method's calculation. Further, separate columns can be provided for the other scores and statistics, such as the PACS and ES scores, produced by the methods.

Secreted Proteins Data Output

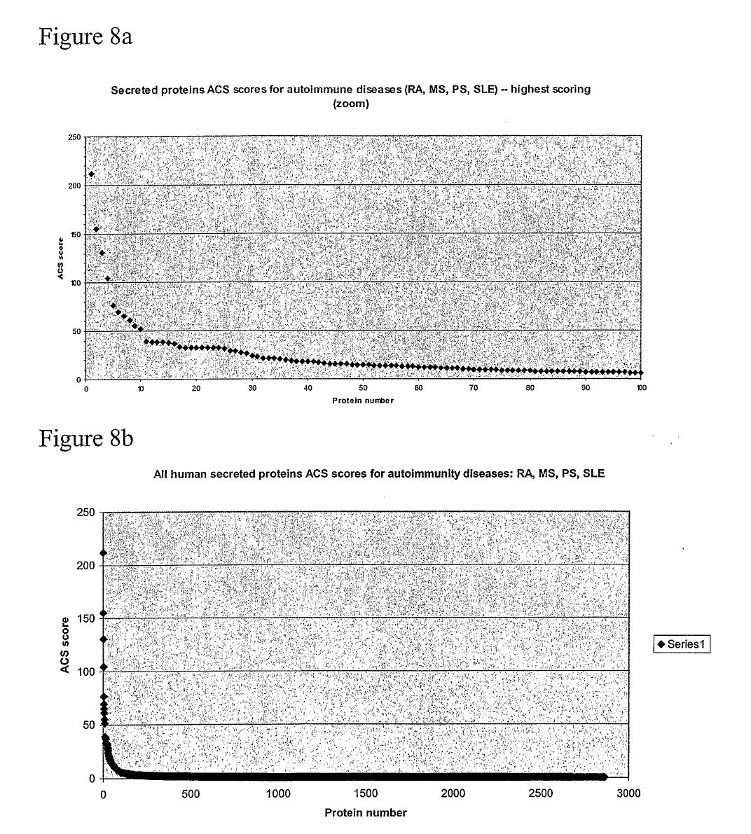

In the case of performing a study on secreted proteins, FIGS. 8a and 8b are other examples of data reported to a researcher. FIG. 8a is cut-off from a graph of secreted proteins ACS scores for autoimmune diseases (RA, MS, PS, SLE). FIG. 8b is the entire graph of secreted proteins ACS scores for autoimmune diseases (RA, MS, PS, SLE). These graphs are plots of the protein number against the ACS_{LOD} scores as described in tables of a type similar to that of Table 1. The proteins with high ACS_{LOD} scores are those proteins that are likely candidates for further study. As can be discerned from FIGS. 8a and 8b as well as tables such as those of the type of Table 1, the method and system provide researchers a tool and the data to quickly select a small number of proteins from a much larger pool of proteins. This small number of proteins is best suited for a more comprehensive, time-consuming and expensive study program.

### APPENDIX A

1. Kong A, Cox N J (1997) Allele-sharing models: LOD scores and accurate linkage tests. Am J Hum Genet 61:1179-88
2. Kong A, et al. A high-resolution recombination map of the human genome Nature Genetics (Vol. 33 No. 3)
3. Sonnhammer, E. L. L., Eddy, S. R., Birney, E., Bateman, A., and Durbin, R. (1998). Pfam: Multiple sequence alignments and HMM-profiles of protein domains. Nucl. Acids Res., 26:320-322.
4. Eddy, S. R. (2001) HMMER: Profile hidden Markov models for biological sequence analysis http://hmmer.wustl.edu/
5. Horn F., Vriend G., and Cohen F. E. (2001) Collecting and Harvesting Biological Data: The GPCRDB & NucleaRDB Databases. Nucleic Acids Res. 29:346-349.
6. Hembrough T. A., Swerdlow B., Swartz G. M., Plum S, Smith W., Fogler W. and Pribluda V. S. (2003) “Novel antagonists of Par-2: inhibition of tumor growth, angiogenesis, and inflammation.” Blood 2003, 102:11 (poster abstract) http://www.entremed.com/pdfs/PAR-2_FINAL.pdf (poster)
7. Ferrell W R, Lockhart J C, Kelso E B, Dunning L, Plevin R, Meek S E, Smith A J, Hunter G D, McLean J S, McGarry F, Ramage R, Jiang L, Kanke T, Kawagoe J. (2003) “Essential role for proteinase-activated receptor-2 in arthritis.” J. Clin. Invest. 11: 35-41
8. Kosambi, D. D., 1943 “The estimation of map distances from recombination values.” Ann. Eugen. 12:172-175.

What is claimed is:

1. A method for calculating average contribution scores for features to traits including, the steps of:
obtaining genomic association data from at least two studies providing scores of markers for genomic linkages to at least one trait;
selecting features to characterize;
calculating a distance between the features and the markers based on genomic data;
calculating an average contribution score for the features based on the calculated distance between the features and the markers as well as the scores of markers; and
reporting the average contribution score for the features.

2. The method of claim 1, wherein the trait is a disease.

3. The method of claim 1, wherein the study is a probabilistic study.

4. The method of claim 3, wherein:
the genomic association data is a log-odds likelihood of a genomic region associated with a trait;
the scores of the markers are log-odds scores; and
the distances are physical distances.

5. The method of claim 3, wherein:
the genomic association data is an association p-value of a trait;
the scores for the markers are association p-value scores; and
the distances are genetic distances.

6. The method of claim 4, wherein the selected features used in the calculating steps are within 10 Mb of a marker.

7. The method of claim 5, wherein the selected features used in the calculating steps are within 10 cM of a marker.

8. The method of claim 1, wherein the distance calculation is performed with radiation hybrid distances.

9. The method of claim 1, wherein the distance calculation is performed with genetic distances.

10. The method of claim 1, wherein the distance calculation is performed with physical distances.

11. The method of claim 1, wherein the scores of markers are determined from the genomic association data.

12. The method of claim 1, wherein the features are genomic regions.

13. The method of claim 1, wherein the features are sequence features.

14. A method for calculating probability weighted average contribution scores for features to traits including, the steps of:
obtaining genomic association data from at least two studies providing scores of markers for genomic linkages to at least one trait;
selecting features to characterize;
calculating a distance between the features and the markers;
calculating recombination likelihoods of the features and markers;
calculating probability-weighted contribution scores for the features;
calculating a set of statistics for the features; and
reporting at least one of the set of statistics.

15. The method of claim 14, wherein the trait is a disease.

16. The method of claim 14, wherein the study is a probabilistic study.

17. The method of claim 16, wherein:
the genomic association data is a log-odds likelihood of a genomic region associated with a trait;
the scores for the markers are log-odds scores; and
the distances are physical distances.

18. The method of claim 16, wherein:
the genomic association data is an association p-value of a trait;
the scores for the markers are association p-value scores; and
the distances are genetic distances.

19. The method of claim 17, wherein the markers used in the calculating steps are within 10 Mb of a feature.

20. The method of claim 18 wherein the markers used in the calculating steps are within 10 cM of a feature.

21. The method of claim 14, wherein the distance calculation is performed with radiation hybrid distances.

22. The method of claim 14, wherein the distance calculation is performed with genetic distances.

23. The method of claim 14, wherein the distance calculation is performed with physical distances.

24. The method of claim 14, further including the step of calculating the probability that a feature and marker will not recombine.

25. The method of claim 14, wherein the reported statistics for a marker includes:
a PACS_{LOD} scores;
an ES_{LOD} score;
a PACS_{ASN} score;
an ES_{ASN} score; and
an ES_{CMB} score.

26. The method of claim 14, wherein the reported statistics for a marker includes at least one of:
a PACS_{LOD} score;
an ES_{LOD} score;
a PACS_{ASN} score;
an ES_{ASN} score; and
an ES_{CMB} score.

27. The method of claim 14, wherein the features are genomic regions.

28. The method of claim 14, wherein the features are sequence features.

29. A method for calculating probability weighted average contribution scores for features to traits including, the steps of:
obtaining genomic association data from at least two studies providing scores of markers for genomic linkages to at least one trait;
selecting features to characterize;
calculating a distance between the features and the markers;
calculating a recombination likelihood of the features and markers;
calculating contribution scores for the features;
calculating probability-weighted contribution scores for the features;
calculating combined contribution scores for the features;
calculating a set of statistics for the features; and
reporting at least one of the set of statistics.

30. A system for calculating average contribution scores for features to traits including:
an input module including logic configured to obtain genomic association data from at least two studies providing scores of markers for genomic linkages to at least one trait and logic configured to obtain features to characterize;
a computation module, connected to the input module, including calculation logic configured to calculate:
a distance between the features and the markers based on genomic data; and
an average contribution score for the features based on the calculated distance
between the features and the markers as well as the scores of markers; and
an output module, connected to the computation module, including logic configured to report the average contribution score for the features.

31. The system of claim 30, wherein the trait is a disease.

32. The system of claim 30, wherein the study is a probabilistic study.

33. The system of claim 32, wherein:
the genomic association data is a log-odds likelihood of a genomic region associated with a trait;
the scores of the markers are log-odds scores; and
the distances are physical distances.

34. The system of claim 32 wherein:
the genomic association data is an association p-value of a trait;
the scores for the markers are association p-value scores; and
the distances are genetic distances.

35. The system of claim 33, wherein the features used by the calculation logic are within 10 Mb of at least one of the markers.

36. The system of claim 34, wherein the features used by the calculation logic are within 10 cM of at least one of the markers.

37. The system of claim 30, wherein the calculation logic is configured to calculate the distance between the features and the markers with radiation hybrid distances.

38. The system of claim 30, wherein the calculation logic is configured to calculate the distance between the features and the markers with genetic distances.

39. The system of claim 30, wherein the calculation logic is configured to calculate the distance between the features and the markers with physical distances.

40. The system of claim 30, wherein the scores of features are determined from the genomic association data.

41. The system of claim 30, wherein the features are genomic regions.

42. The system of claim 30, wherein the features are sequence features.

43. A system for calculating probability weighted average contribution scores for features to traits including:
an input module including logic configured to obtain genomic association data from at least two studies providing scores of markers for genomic linkages to at least one trait and logic configured to obtain features to characterize;
a computation module, connected to the input module, including calculation logic configured to calculate:
a distance between the features and the markers;
a recombination likelihood of the features and markers;
a probability-weighted contribution score for the features; and
a set of statistics for the features; and
an output module, connected to the computation module, including logic configured to report at least one of the set of statistics.

44. The system of claim 43, wherein the trait is a disease.

45. The system of claim 43, wherein the study is a probabilistic study.

46. The system of claim 45, wherein:
the genomic association data is a log-odds likelihood of a genomic region associated with a trait;
the scores for the markers are log-odds scores; and
the distances are physical distances.

47. The system of claim 45, wherein:
the genomic association data is an association p-value of a trait;
the scores for the markers are association p-value scores; and
the distances are genetic distances.

48. The system of claim 46, wherein the markers used by the calculation logic are within 10 Mb of at least one of the features.

49. The system of claim 47, wherein the markers used by the calculation logic are within 10 cM of at least one of the features.

50. The system of claim 43, wherein the calculation logic is configured to calculate the distance between the features and the markers with radiation hybrid distances.

51. The system of claim 43, wherein the calculation logic is configured to calculate the distance between the features and the markers with genetic distances.

52. The system of claim 43, wherein the calculation logic is configured to calculate the distance between the features and the markers with physical distances.

53. The system of claim 43, wherein the calculation logic is further configured to calculate the probability that a feature and marker will not recombine.

54. The system of claim 43, wherein the statistics include:
a PACS_{LOD} score;
an ES_{LOD} score;
a PACS_{ASN} score;
an ES_{ASN} score; and
an ES_{CMB} score.

55. The system of claim 43, wherein the statistics include at least one of:
a PACS_{LOD} score;
an ES_{LOD} score;
a PACS_{ASN} score;
an ES_{ASN} score; and
an ES_{CMB} score.

56. The system of claim 43, wherein the features are genomic regions.

57. The system of claim 43, wherein the features are sequence features.

58. A system for calculating probability weighted average contribution scores for features to traits including:
an input module including logic configured to obtain genomic association data from at least two studies providing scores of markers for genomic linkages to at least one trait and logic configured to obtain features to characterize;
a computation module, connected to the input module, including calculation logic configured to calculate:
a distance between the features and the markers;
a recombination likelihood of the features and markers;
contribution scores for the features;
probability-weighted contribution scores for the features;
combined contribution scores for the features; and
a set of statistics for the features; and
an output module, connected to the computation module, including logic configured to report at least one of the set of statistics for the features.
